(19) United States
(12) Patent Application Publication
(10) Pub. No.: US 2025/0272577 A1
(43) Pub. Date: Aug. 28, 2025

(54) ITERATIVE PROMPT TRAINER AND REPORT GENERATOR

(71) Applicant: CHEMTREAT, INC., Glenn Allen, VA (US)

(72) Inventor: David C. THOMPSON, Carlsbad, CA (US)

(73) Assignee: CHEMTREAT, INC., Glen Allen, VA (US)

(21) Appl. No.: 18/584,647

(22) Filed: Feb. 22, 2024

(51) Int. Cl. G06N 5/01

(52) U.S. Cl. CPC G06N 5/01

(57) ABSTRACT

An iterative prompt training apparatus receives a search request for searching for information and automatically generates a first prompt instructing a large language model to search for the information requested in the search request. The iterative prompt training apparatus provides the first prompt to the large language model and analyzes a first search result, output by the large language model based on the first prompt, to determine whether an error exists in the first search result. In response to determining that the error exists in the first search result, the iterative prompt training apparatus automatically executes prompt adjustment to generate a second prompt that is different from the first prompt and provides the second prompt to the large language model.

### BACKGROUND

The use of large language models (“LLMs”) to search for and report information is critical across a variety of industries. These LLMs undergo various levels of training. Conventionally, LLMs used in, for example, Internet search engines receive input in the form of a query and return a search result based on that query.

However, one technological problem with conventional LLMs is their inability to automatically refine the originally received query to return a more accurate and relevant search result. In particular, after obtaining an initial search result, conventional LLMs and their associated computer processors are unable to automatically refine the prompt or query to adjust search content and/or search sources to obtain a more relevant search result. In addition, conventional LLMs do not automatically adjust the scope of their searches when search prompts are too broad or too narrow, thus failing to obtain the most relevant result.

### SUMMARY

The inventor of this application discovered that the conventional LLMs can be improved by using an iterative prompt trainer that iteratively refines the search prompt. By doing so, the iterative prompt trainer of this application obtains a more relevant search result based on prompt refinement and scope adjustment.

One object of the present disclosure is to provide a highly accurate iterative prompt trainer to overcome the above inefficiencies of conventional LLMs. Another object of the present disclosure is to provide an improved report generator that automatically organizes and outputs the refined result of the LLM that has been trained by the iterative prompt trainer.

According to one aspect, the disclosure provides an iterative prompt training apparatus. The iterative prompt training apparatus receives a search request for searching for information and automatically generates a first prompt instructing a large language model to search for the information requested in the search request. The iterative prompt training apparatus provides the first prompt to the large language model and analyzes a first search result, output by the large language model based on the first prompt, to determine whether an error exists in the first search result. In response to determining that the error exists in the first search result, the iterative prompt training apparatus automatically executes prompt adjustment to generate a second prompt that is different from the first prompt and provides the second prompt to the large language model.

According to another aspect, the disclosure provides an iterative prompt training method. The iterative prompt training method receives a search request for searching for information and automatically generates a first prompt instructing a large language model to search for the information requested in the search request. The iterative prompt training method provides the first prompt to the large language model and analyzes a first search result, output by the large language model based on the first prompt, to determine whether an error exists in the first search result. In response to determining that the error exists in the first search result, the iterative prompt training method automatically executes prompt adjustment to generate a second prompt that is different from the first prompt and provides the second prompt to the large language model.

### BRIEF DESCRIPTION OF THE DRAWINGS

FIG. 1 is a block diagram of an iterative prompt trainer according to an embodiment.

FIG. 2 is an image of an example of a display of a user interface for inputting a search request.

FIG. 3 is flowchart showing an iterative prompt training method according to an embodiment.

FIG. 4 is an image of an example of a display of a report generated based on a search request.

### DETAILED DESCRIPTION OF EMBODIMENTS

In the following description, numerous details are set forth to provide an understanding of the present disclosure. However, it is understood by those skilled in the art that the apparatus and method of the present disclosure may be practiced without these details and that numerous variations or modifications from the described embodiments may be possible.

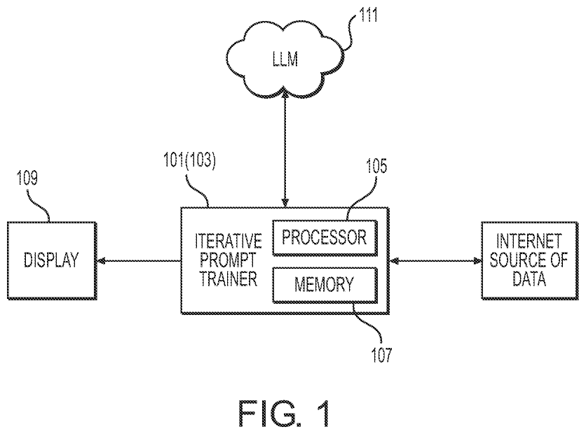

Embodiments of the present disclosure provide an apparatus and a method for the iterative prompt training of an LLM, the execution of the iterative searching by the LLM, and the output by a report generator of the refined search result. These and other features are described in detail below in connection with FIGS. 1 to 4.

### (1) Large Language Model

The iterative prompt trainer of the present disclosure controls a large language model, and thus a brief description of LLMs is provided. LLMs are well-known in the art. LLMs are large deep learning models that are pre-trained on vast amounts of data. The transformer of an LLM includes a set of neural networks that act as an encoder and decoder. The transformer's self-attention mechanism enables the model to consider different parts of an input sequence (e.g., a search query) with varying attention weights. Each of the many layers of the LLM refines the representation of the input by applying self-attention mechanisms and feed-forward neural networks. At the input layer, tokens from the text are transformed into high-dimensional vectors through an embedding layer. This layer maps each token to a vector representation, capturing semantic information and relationships between words. The core of the transformer, the attention mechanism, allows the model to weigh the importance of each token in the context of the entire sequence. Self-attention enables the LLM to capture long-range dependencies and relationships between words.

During training, the LLM learns optimal parameters (e.g., weights and biases) by minimizing the difference between its generated output and the actual target data. This is achieved through back-propagation and optimization algorithms like stochastic gradient descent.

In operation, the LLM processes input through layers of self-attention mechanisms, generating contextual embeddings, and auto-regressively producing text during inference. Tokens are given attention scores based on their relevance to other tokens, allowing the model to understand the contextual dependencies within the sequence. The model generates contextual embeddings for each token in the sequence. The embeddings capture not only the inherent meaning of each word but also its meaning in the context of the surrounding words. During inference, the model operates in an auto-regressive manner. It generates one token at a time, considering the previously generated tokens as context. This process continues until the desired length of the generated text is reached.

### (2) Iterative Prompt Trainer

The iterative prompt trainer 1 of the present disclosure generates prompts to control an LLM. The LLM controlled by the iterative prompt trainer may be any pre-trained LLM, such as the ones described above. One example of such an LLM is “CHATGPT.” Because the LLM is pre-trained, the iterative prompt trainer does not perform the initial training of the LLM. Rather, by controlling the LLM through iterative prompts, the iterative prompt trainer achieves further training of the LLM while also improving the search result output by the LLM.

### (2-1) Explanation of Hardware and Software

Referring to FIG. 1, the iterative prompt trainer of the present application (e.g., trainer 101) may be implemented by an iterative prompt training apparatus (e.g., apparatus 103). The iterative prompt training apparatus may be, for example, a physical server or circuitry of a physical server or other computer. Alternatively, the iterative prompt training apparatus may be a cloud server, or virtual circuitry of an abstraction layer of a cloud server, running in a cloud computing environment on the Internet. The iterative prompt training apparatus can include a processor (e.g., processor 105) and a memory (e.g., memory 107). The iterative prompt training apparatus may optionally include a display or may, alternatively, transmit information and control signals to a display (e.g., display 109). The memory stores information (for example, programs and various data), and the processor functions based on the information stored in the memory. The functions of the processor may be realized by individual hardware, or may be realized by integrated hardware. Also, the processor, the memory and the display may be integrated in the iterative prompt training apparatus, as shown in FIG. 1. Alternatively, the processor, the memory and the display may be partially or completely remotely arranged with respect to each other. For example, the display may be remotely located and connected to the processor via a network (not shown). The network may include a wireless communication network, the Internet, a VPN (Virtual Private Network), a WAN (Wide Area Network), a wired network, or any combination of these.

The processor may be, for example, a central processing unit (CPU). However, the processor is not limited to a CPU, and various processors such as a graphics processing unit (GPU) or a digital signal processor (DSP) can be used. The processor may be a hardware circuit based on an application-specific integrated circuit (ASIC). The term “processor” encompasses a single processor or a group of multiple processors located either locally or remotely working together or in a distributed fashion to collectively perform the tasks attributed to the “processor” described herein.

The memory may be a semiconductor memory such as a static random access memory (SRAM) or a dynamic random access memory (DRAM), a register, a magnetic storage device such as a hard disk device, or an optical storage device such as an optical disk device. For example, the memory stores computer readable instructions, and the processor executes the instructions to realize the function of each part of the apparatus and method. The instructions here may be instructions constituting the program or instructions for the hardware circuit of the processor to perform the method.

The display includes a display device such as a liquid crystal display or an organic EL (electro-luminescent) display. The display can display various images. The display is constituted by, for example, a computer screen, and functions to display data output by the processor. The processor may cause the display to output information including display images. Alternatively, the processor may transmit data to another processor which in turn causes the display to output the information including the display images.

### (2-2) Iterative Prompt Training

The iterative prompt training apparatus automatically executes methods for iterative prompt training to control the LLM (e.g., LLM 111). The following exemplary embodiments describe the application of these features to improve the ability of the LLM to search for and output information.

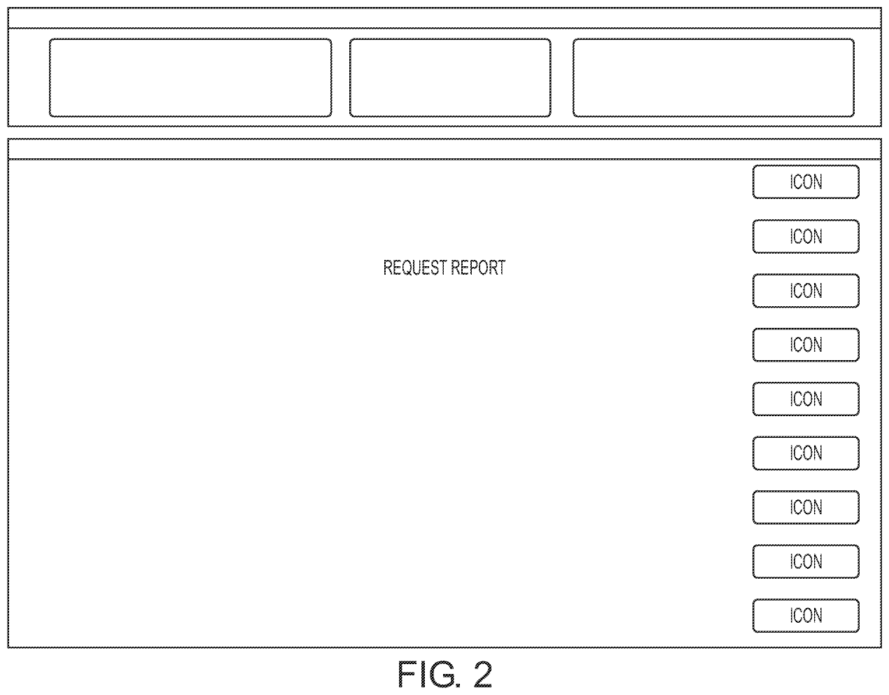

The iterative prompt training apparatus receives each search request (e.g., for searching for information) via the user interface displayed on the display. One example of the user interface is shown in FIG. 2. The user interface includes one or more icons by which a user (requester) defines the search request. Based on the search request, the iterative prompt training apparatus identifies one or more sources of information that the LLM is required to use in its search. The iterative prompt training apparatus may also identify requester information, as discussed below.

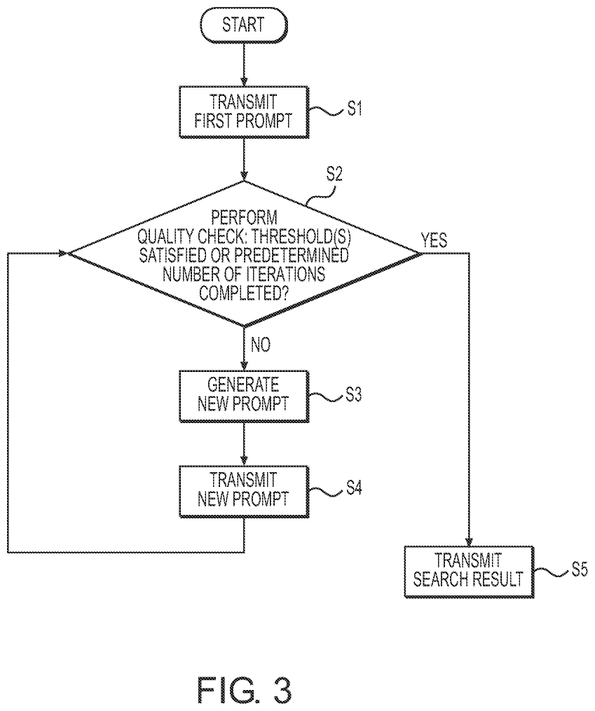

Upon receiving the search request via the user interface, the iterative prompt training apparatus executes the following process, shown in FIG. 3. First, the iterative prompt training apparatus automatically generates and sends (e.g., to the LLM) a first prompt instructing the LLM to search for the information requested in the search request (step S1). More specifically, this first prompt includes the content of the search request and one or more sources of information that the LLM is required to use in its search. The one or more sources of information might include, for example, academic journals, government publications, documents filed with the U.S. Securities and Exchange Commission, official company websites, etc. Based on the first prompt provided to the LLM by the iterative prompt training apparatus, the LLM automatically searches the indicated sources as well as other sources of information that the LLM determines, based on previous training, to be relevant to the search request. These additional sources of information are determined by the LLM using well-known LLM techniques that take into consideration such things as the security of an information source (e.g., the trustworthiness of a website), the number of cross-references made for that source in other sources, and so on.

Optionally, the first prompt may also include requester information of the search requester which the LLM uses to identify additional sources to search, or the first prompt may include an instruction for the LLM to retrieve the requester information. For example, the requester information may include the requester's personal information, company position, and date of request. Based on the requester information, the LLM more accurately searches for information relevant to the requester. In other words, the first prompt from the iterative prompt training apparatus causes the LLM to further train itself (i.e., optimize) to more accurately retrieve a search result relevant to a particular requester.

Next, in step S2, after the LLM completes its initial search, the iterative prompt training apparatus performs a quality check on the search result. In particular, the iterative prompt training apparatus analyzes the search result to determine whether the search result satisfies one or more predetermined thresholds. The predetermined thresholds include, for example, a predetermined character count, a predetermined word count, and/or a predetermined phrase or set of phrases.

In response to determining that the search result satisfies the one or more predetermined thresholds, the iterative prompt training apparatus causes the LLM to transmit the search result to a report generator (discussed further below), or the iterative prompt training apparatus itself transmits the search result to the report generator, in order to output the search result in a predetermined format (step S5). The iterative prompt training apparatus does not instruct the LLM to transmit the search result until the search result satisfies the one or more predetermined thresholds. To this end, the prompts generated by the iterative prompt training apparatus may further include a command that the LLM not provide details or summaries of the search result until the search result satisfies the one or more predetermined thresholds. In this way, processing and network resources required to transmit the data are conserved.

On the other hand, in response to determining that the search result does not satisfy the one or more predetermined thresholds (i.e., that an error exists in the search result), the iterative prompt training apparatus generates a second prompt that is different from the first prompt (step S3). Specifically, the second prompt is a modified version of the first prompt in which one or more parameters of the first prompt have been changed. For example, the second prompt may differ from the first prompt in the content of the search request and/or the sources of information the LLM is required to use in its search. In this case, the content of the search request in the second prompt can be reduced, supplemented, or reorganized relative to that of the first prompt. Similarly, the sources of information in the second prompt may be reduced or supplemented. The second prompt may also include new restrictions on the type and/or quantity of sources of information the LLM may use in its search.

In addition to modifying the prompt content when generating the second prompt, the iterative prompt training apparatus may also modify the one or more predetermined thresholds. In this case, the information resulting from the search performed based on the second prompt would be analyzed with reference to the modified thresholds.

Next, the iterative prompt training apparatus sends the second prompt to the LLM to search for the information requested in the search request (step S4). After this, the iterative prompt training apparatus repeats steps S2 to S4 continuously until the one or more predetermined thresholds are satisfied. Alternatively, the iterative prompt training apparatus repeats steps S2 to S4 continuously until a predetermined number of iterations of steps S2 to S4 are completed.

Each iteration of step S3 refines the prompt (i.e., generates a new prompt, also known as prompt adjustment) which causes the LLM to search differently for the information. In this way, the iterations of the search cause the LLM to use different sources of information, to search the sources of information differently, and to retrieve a more relevant search result.

According to the disclosed method, the iterative prompt training apparatus automatically iterates to resolve errors in the search result. The iterative prompt training apparatus iteratively modifies and refines the prompt provided to the LLM, thereby training the LLM to more accurately search for the information, to obtain more relevant results.

### (2-3) Other Error Corrections

The iterative prompt training apparatus is configured to address other errors as well using iterative prompts. Examples of such errors include a timeout error, a resource limitation error, a command error, a network or connectivity error, a policy violation error, and an ambiguous instruction error.

A timeout error occurs when the execution of a prompt exceeds an allocated time limit. For example, when a time limit (e.g., 60 seconds) is allocated to the LLM's search based on the first prompt and the iterative prompt training apparatus determines that the search time has exceeded the time limit, the iterative prompt training apparatus determines that a timeout error has occurred. In this case, the iterative prompt training apparatus automatically generates a second prompt that differs from the first prompt by limiting the number of sources of information the LLM may use in the search. The iterative prompt training apparatus repeats this iterative adjustment of the prompt until the search time no longer exceeds the time limit or until a predetermined number of iterations has been completed.

A resource limitation error occurs when the search requires more processing resources than are available. The iterative prompt training apparatus compares the memory and/or processing power of the iterative prompt training apparatus allocated to the search and, if the demand of the search exceeds the allocated power, the iterative prompt training apparatus determines a resource limitation error has occurred. In this case, the iterative prompt training apparatus automatically generates a second prompt that differs from the first prompt by limiting the content and/or information sources of the search. The iterative prompt training apparatus repeats this iterative adjustment of the prompt until the required processing resources no longer exceed the allocated resources or until a predetermined number of iterations has been completed.

A command error or syntax error occurs when programming language includes incorrect code, or when the received search request is improperly formatted. When the iterative prompt training apparatus determines that a command error has occurred after one or more iterations of prompt adjustment, the iterative prompt training apparatus instructs the LLM to search again based on the original non-iterated first prompt. If the command error occurs again, the iterative prompt training apparatus ends the search.

A network or connectivity error occurs when a failure in communication internal or external to the iterative prompt training apparatus exists. When the iterative prompt training apparatus determines that a network or connectivity error has occurred, the iterative prompt training apparatus adjusts the frequency of prompt delivery by, for example, adding a delay at intervals of 60 seconds. In other words, when the iterative prompt training apparatus iteratively generates and provides new prompts to the LLM as discussed above, the iterative prompt training apparatus adjusts the frequency at which the new prompts are transmitted to the LLM to address the network or connectivity error.

A policy violation error occurs when the search content in a prompt violates specific content policies of the LLM. A policy violation error may result in a search failure or a request for clarification of the search. When the iterative prompt training apparatus determines that a policy violation error has occurred after one or more iterations of prompt adjustment, the iterative prompt training apparatus instructs the LLM to search again based on the original non-iterated first prompt. If the policy violation error occurs again, the iterative prompt training apparatus ends the search.

An ambiguous instruction error occurs when a prompt is too vague or unclear for the LLM to understand what is being asked. An ambiguous instruction error may result in a search failure or a request for clarification of the search. When the iterative prompt training apparatus determines that an ambiguous instruction error has occurred after one or more iterations of prompt adjustment, the iterative prompt training apparatus instructs the LLM to search again based on the original non-iterated first prompt. If the ambiguous instruction error occurs again, the iterative prompt training apparatus ends the search.

### (2-4) Technical Advantages

As discussed above, conventional LLMs and their associated computer processors are technologically problematic due to their inability to automatically refine a search query to return a more accurate and relevant search result. The iterative prompt training apparatus of this present disclosure solves this problem by automatically iterating to resolve errors in the search result. The iterative prompt training apparatus iteratively modifies and refines the prompt provided to the LLM, thereby training the LLM to more accurately search for the information, to obtain more relevant results. Thus, unlike conventional LLMs and their associated computer processors, the disclosed iterative prompt training apparatus is able to automatically adjust and refine the search prompts to train the LLM to obtain more relevant results. In doing so, the iterative prompt training apparatus can also adjust the scope of the search with each iteration, thereby instructing the LLM to search differently across different information ranges in a way that conventional LLMs and their associated computer processors are unable to do.

In addition, because the iterative prompt training apparatus does not instruct the LLM to transmit the search result until the search result satisfies the one or more predetermined thresholds, processing and network loads may be reduced as compared to conventional LLMs and their associated computer processors that transmit or otherwise output the search result data after each search. To this end, the prompts generated by the iterative prompt training apparatus may further include a command that the LLM not provide details or summaries of the search result until the search result satisfies the one or more predetermined thresholds. The conventional LLMs and their associated computer processors fail to include such a command in their search prompts and thus fail to conserve processing and network resources.

### (3) Report Generator

As mentioned above, in response to determining that the search result satisfies the one or more predetermined thresholds, the iterative prompt training apparatus causes a report generator to output the search result in a predetermined format. The report generator may be a separate apparatus or may be a function of the iterative prompt training apparatus. The report generator receives the search result from the LLM and outputs the search result in a predetermined format.

In particular, the report generator automatically rearranges the information in the search report by, for example, searching for key words and parsing out statements related to the key words. The report generator may also insert the parsed out statements into predefined categories.

Alternatively, the report generator or the iterative prompt training apparatus may generate a parsing prompt instructing the LLM to parse out statements related to the key words and generate a response with the parsed statements categorized into the predefined categories.

The predefined categories may be automatically determined or may be determined according to the content of the search request input by the user via the user interface. For example, the user may use the icons displayed on the user interface to select the predefined categories for the report at the time of making the search request.

The report generator may also analyze the data to identify additional pertinent information such as trends or other statistics. For example, if the search request is related to goal identification in ESG (environmental, social, and corporate governance), the additional pertinent information may include statistics and insights that could influence goal identification and generation.

The report generator then automatically generates a report including the categorized parsed statements and any additional pertinent information. The report may be generated in a predetermined format, such as a text-only infographic in outline form with bullet points and statements related to the bullet points. Alternatively, the format of the report may be customized according to the requester information. In addition, or alternatively, the format of the report may be customized according to format selections made by the user via the icons displayed on the user interface at the time of making the search request.

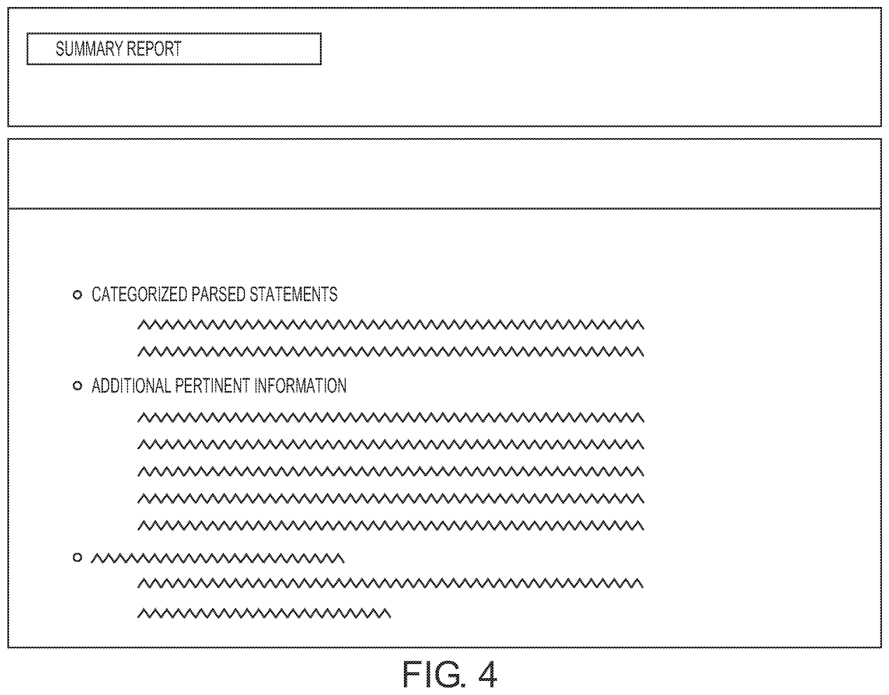

The report generator then causes the report to be displayed on the display or transmits the report to another apparatus for display. One example of the generated report as displayed is shown in FIG. 4. With the disclosed report generator, the refined result of the LLM that has been trained by the iterative prompt trainer is automatically analyzed, parsed, organized, and output for display to a user. Accordingly, the displayed report includes information that is more relevant to the user and that is displayed in a more relevant manner.

It will be appreciated that the above-disclosed features and functions, or alternatives thereof, may be desirably combined into different systems, apparatuses, and methods. Also, various alternatives, modifications, variations or improvements may be subsequently made by those skilled in the art and are also intended to be encompassed by the disclosed embodiments. As such, various changes may be made without departing from the spirit and scope of this disclosure.

1. An iterative prompt training apparatus comprising:
one or more processors programmed to:
receive a search request for searching for information;
automatically generate a first prompt instructing a large language model to search for the information requested in the search request;
provide the first prompt to the large language model;
analyze a first search result, output by the large language model based on the first prompt, to determine whether an error exists in the first search result;
in response to determining that the error exists in the first search result, identify a source of information that the large language model is required to use in searching and automatically execute prompt adjustment to generate a second prompt that is different from the first prompt, wherein the second prompt includes the source of information; and
provide the second prompt to the large language model.

2. The iterative prompt training apparatus according to claim 1, wherein
the error is determined to exist when the first search result fails to meet one or more predetermined thresholds.

3. The iterative prompt training apparatus according to claim 1, wherein
the error is determined to exist when execution of the first prompt by the large language model exceeds an allocated time limit.

4. The iterative prompt training apparatus according to claim 1, wherein
the error is determined to exist when searching based on the first prompt exceeds available processing resources.

5. The iterative prompt training apparatus according to claim 1, wherein
the error is a network or connectivity error.

6. The iterative prompt training apparatus according to claim 1, wherein
the second prompt differs from the first prompt in at least one of content of the search request and the source of information the large language model uses in searching for the information requested in the search request.

7. The iterative prompt training apparatus according to claim 1, wherein
the one or more processors repeat the prompt adjustment iteratively until one or more predetermined thresholds are satisfied or until a predetermined number of prompt adjustment iterations are completed.

8. The iterative prompt training apparatus according to claim 1, wherein
in response to determining that the error does not exist in the first search result, the one or more processors cause a report to be generated and output to a display.

9. The iterative prompt training apparatus according to claim 8, wherein
the one or more processors generate a parsing prompt instructing the large language model to parse out statements from the first search result and generate, as the report, a response with the parsed statements categorized into predefined categories.

10. An iterative prompt training method comprising:
receiving a search request for searching for information;
automatically generating a first prompt instructing a large language model to search for the information requested in the search request;
providing the first prompt to the large language model;
analyzing a first search result, output by the large language model based on the first prompt, to determine whether an error exists in the first search result;
in response to determining that the error exists in the first search result, identifying a source of information that the large language model is required to use in searching and automatically executing prompt adjustment to generate a second prompt that is different from the first prompt, wherein the second prompt includes the source of information; and
providing the second prompt to the large language model.

11. The iterative prompt training method according to claim 10, wherein
the error is determined to exist when the first search result fails to meet one or more predetermined thresholds.

12. The iterative prompt training method according to claim 10, wherein
the error is determined to exist when execution of the first prompt by the large language model exceeds an allocated time limit.

13. The iterative prompt training method according to claim 10, wherein
the error is determined to exist when searching based on the first prompt exceeds available processing resources.

14. The iterative prompt training method according to claim 10, wherein
the error is a network or connectivity error.

15. The iterative prompt training method according to claim 10, wherein
the second prompt differs from the first prompt in at least one of content of the search request and the source of information the large language model uses in searching for the information requested in the search request.

16. The iterative prompt training method according to claim 10, wherein
the prompt adjustment is repeated iteratively until one or more predetermined thresholds are satisfied or until a predetermined number of prompt adjustment iterations are completed.

17. The iterative prompt training method according to claim 10, further comprising
in response to determining that the error does not exist in the first search result, causing a report to be generated and output to a display.

18. The iterative prompt training method according to claim 17, further comprising
generating a parsing prompt instructing the large language model to parse out statements from the first search result and generate, as the report, a response with the parsed statements categorized into predefined categories.
